(19) United States
(12) Patent Application Publication
(10) Pub. No.: US 2004/0249710 A1
(43) Pub. Date: Dec. 9, 2004

(54) Methods and apparatus for implementing loyalty programs using portable electronic data storage devices

(76) Inventors: David Smith, Atlanta, GA (US); Regina Montefeltri, New York, NY (US)

Correspondence Address: STRAUB & POKOTYLO, 620 TINTON AVENUE, BLDG. B, 2ND FLOOR, TINTON FALLS, NJ, 07724, US

(21) Appl. No.: 10/844,731

(22) Filed: May 13, 2004

Related U.S. Application Data
(60) Provisional application No. 60/471,185, filed on May 16, 2003.

(51) Int. Cl. G06F 17/60; G06K 19/06

(52) U.S. Cl. 705/14

(57) ABSTRACT

Customer loyalty programs using portable data storage devices, e.g., smart cards, are described. Merchant terminals capable of reading and writing information to user smart cards are used to award points to customers based on a set of loyalty program information stored in the merchant terminal, at least some information read from the smart card, and information such as the purchase amount. Different terminals within a store maybe loaded with different loyalty program information allowing the program to be specific to a store department or location. Updating of loyalty program information from a server facilitates implementation of rapid changes in plans allowing plans to be modified or an hourly basis if desired as part of a particular promotion in a department. Bonus loyalty information is stored in the user device, eliminating any need to access a centralized location which stores point information to award and/or redeem loyalty awards.

### RELATED APPLICATIONS

The present application claims the benefit of U.S. Provisional Patent Application Ser. No. 60/471,185, filed May 16, 2003 which is hereby expressly incorporated by reference.

### FIELD OF THE INVENTION

The present invention relates generally to the field of loyalty programs, and, more particularly, to methods and apparatus for implementing loyalty programs using portable electronic data storage and retrieval devices, e.g., smart cards.

### BACKGROUND OF THE INVENTION

In order to promote sales and encourage customer loyalty, many merchants, e.g., stores, restaurants, airlines, who sell goods or services, often implement customer loyalty programs. Such programs are often implemented by assigning a customer a physical card, e.g., a paper card, which is then stamped by the retailer to indicate the awarding of one or more points for the purchase of a product or service. When a sufficient number of awards, e.g., loyalty points, are accumulated, in many cases the customer is allowed to redeem the accumulated points towards a product purchase, an award and/or a discount. One of the most common examples of such a customer loyalty program is a lunch card which is stamped each time a lunch is purchase and which can then be redeemed, e.g. after a fixed number of stamps, for a free lunch or discount on a lunch. In the case of lunch based loyalty programs, there is usually no centralized tracking of the number of points accumulated by individual customers. The ease with which ink stamps can be faked and the lack of any electronic accounting in such programs makes such programs the easy target for fraud.

Another example of a loyalty program involves the issuance of paper stamps, with the stamps being used to track the number of bonus points awarded. Historically, such stamps would be glued into books which would be maintained by the customers participating in the loyalty program. The stamps, stored in the books, could then be redeemed for various prizes and/or discounts. Such paper stamp based loyalty programs have fallen out of favor as people have become ever more time conscious and have come to find the collection, storage, and redemption processes associated with paper stamps used for loyalty programs both time consuming and tedious.

Another example of a customer loyalty program is frequent flyer miles. Such programs are widely used today. In the case of a frequent flyer program, an airline normally credits a bonus point for each mile of flight associated with a purchased airline ticket. Airline bonus points may also be accumulated by making purchases using a credit card associated with a particular frequent flyer program. For example, in some cases one bonus point if awarded for each dollar spent using the credit card associated with the loyalty program regardless of where an item is purchased. Airline points may expire if not used within a certain period of time. Airline mileage bonus point programs and credit card bonus programs which provide airline mileage points rely on centralized tracking of bonus points. This reduces the risk of fraud and it allows for points to be deleted at a centralized location if the points expire. However, it also complicates bonus point award redemption procedures. Normally, to redeem the bonus points it must be done by contacting a specific representative, e.g., airline representative, with access to and control over the centralized bonus point tracking database. This makes redemption of bonus points at a wide number of retail locations impractical in many cases due to the limited access and merchant constraints with regard to accessing the bonus tracking system. From a practical standpoint, credit card companies and airlines are reluctant to give a wide variety of merchants the ability to access and directly modify bonus point information.

Given the value of bonus and loyalty programs in attracting and keeping customers, loyalty programs are of great interest to merchants. However, for such programs to gain even greater acceptance and increased levels of utilization, method of implementing such programs need to be improved.

In particular, there is a need for methods of avoiding the paper and ink stamp bonus point tracking systems which have been found to be prone to fraud and/or generally undesirable from a customer perspective due to the amount of work required to maintain and redeem the awarded loyalty points which may be in the form of paper stamps or a paper card. In order to gain widespread acceptance from the merchant perspective, there is a need to allow different merchants to award loyalty points in different amounts and/or for different items. In addition, in the case of an individual merchant owning one or more stores, it is desirable to allow the merchant flexibility in regard to the how the loyalty program is implemented at different stores and even to allow the merchant to offer different loyalty incentives at different locations within a store, e.g., at different points of sale corresponding to different departments.

In order to provide a wide degree of flexibility to a merchant, it would be desirable for a merchant to be able to update loyalty program information in multiple stores and/or to modify loyalty program information for different departments within a store from a centralized location in an automated manner. In addition, it would be desirable if the merchant could obtain access to, and modify information about, the total number of points accumulated by a customer participating in a loyalty point program without the need to contact and access a centralized point tracking system.

### BRIEF DESCRIPTION OF THE FIGURES

FIG. 1 illustrates an exemplary system for managing loyalty schemes implemented in accordance with the present invention and using methods of the present invention.

FIG. 2 illustrates a detailed representation of an exemplary retail store in a first region of the system of FIG. 1, implemented in accordance with the present invention and using methods of the present invention.

FIG. 3 illustrates a detailed representation of another exemplary retail store in a different region of the system of FIG. 1, implemented in accordance with the present invention and using methods of the present invention.

FIG. 4 illustrates an exemplary merchant terminal used for storing loyalty point program information, interfacing with user cards, and calculating loyalty points, the exemplary merchant terminal may be any merchant terminals used in any of the departments of the stores of the system of FIG. 1, the merchant terminal implemented in accordance with the present invention and using methods of the present invention.

FIG. 5 illustrates an exemplary user card, e.g., smart card, used for storing user information, storing loyalty points awarded to the cardholder, and interfacing with merchant terminals, the user card implemented in accordance with the present invention and using methods of the present invention.

FIG. 6 is a drawing of an exemplary server implemented in accordance with the present invention and using methods of the present invention.

FIG. 7 is a combined system and method diagram which shows various system components and steps of a loyalty program method implemented in accordance with one exemplary embodiment of the invention.

### SUMMARY OF THE INVENTION

This invention is directed to methods and apparatus for implementing customer loyalty programs through the use of portable user data storage devices, e.g., smart cards, key chain devices, etc.

Merchant terminals capable of reading and writing information to user smart cards are used to award points to customers based on a set of loyalty program information stored in the individual merchant terminal, at least some information read from the smart card, and information such as the purchase amount. The information read from the smart card upon which an award of points may be based may be, for example, information indicating that the user is a loyalty program member and/or information authenticating the portable user device as a device authorized to receive and store loyalty point award information for the particular loyalty program or programs being implemented at a particular merchant terminal. Information read from the portable user data storage device may be communicated to a credit card provider and/or financial network. In some embodiments the credit card provider and/or financial network returns authentication information verifying the authenticity of the use device and program participation information and/or issuing a fraud warning in the case where the authentication operation fails. The credit card provider may be the issuer of the smart card or user device used to implement the loyalty program of the present invention.

Program participants may belong to different loyalty program levels or programs. In such cases, information read from a user's portable data storage device may indicate the program and/or level with which the user is associated. The merchant terminal may award different numbers of points to different user's based on the program and/or program level indicated by the information read from the user's card.

Multiple merchant terminals within a store may be programmed with the same set of loyalty point program information. Different loyalty point program awards may be specified for items corresponding to different store departments. Managers of individual departments may update the loyalty point program information corresponding to the individual department for which the manager is responsible.

While terminals can be programmed to give different awards for purchases of different items and/or items corresponding to different departments, in some embodiments different terminals within a store are loaded with different loyalty program information allowing the program to be specific to a store department or location.

In some embodiments, different loyalty program award points are maintained on a user's portable data storage device for each of a plurality of departments within a store. Depending on the loyalty program being implemented, the use of awarded loyalty points to obtain discounts or other benefits may be limited to the department of a particular store which issued the points. In other implementations, awarded points from different departments within a store can be aggregated for some point redemption purposes for some awards but not necessarily all awards. For example, point awards from different departments may be aggregated towards one or more items, e.g., a turkey, while points from a specific department may be redeemed to obtain a particular percentage discount on additional purchases from the department which awarded the points.

Point award points may also be identified as corresponding to particular stores. Loyalty program points may be aggregated and redeemed to obtain items or other benefits in some programs but not others. For example, stores with a shopping mall may honor award points issued by other stores in a shopping mall with regard to some items to be awarded in exchange for points but not others. In addition, stores may give greater weight, e.g., value, to loyalty points issued by the store where the awarded points are being redeemed than for points awarded by another store.

As can be appreciated from the above discussion, in various embodiments, the portable user devices store multiple counts of awarded loyalty points, e.g., with each count of awarded points corresponding to different departments within a store, to different stores, and/or to different store chains. At the time of redemption, which awarded points can be redeemed at a particular merchant terminal, the value of the points in terms of an issued award item or discount to be given and/or how different award points are to be aggregated for redemption purposes can vary depending on the set of loyalty program information programmed into the terminal at which a customer seeks to redeem previously awarded loyalty points.

In order to facilitate easy management of the loyalty program by store or regional managers, one or more servers are used to update loyalty program information stored in merchant terminals within a store or region. A local, e.g., store based, server and/or a regional based server is used to update merchant terminals. Updating of loyalty program information from a server facilitates implementation of rapid changes in plans allowing plan information stored in merchant terminals to be modified immediately and/or at a predetermined time such as on a periodic basis, e.g., hourly, weekly or monthly. Department managers can implement particular promotions in a specific department within a store by updating the portion of loyalty program information corresponding to the items within a specific department which are to be promoted and/or by updating the terminals in the specific department. In the case where terminals in the specific department are updated, other terminals in the store may or may not be updated. For example, when the goal is to encourage people to visit the department, the update may be limited to terminals physically located within the department running the promotion thereby encouraging people to visit the department to obtain the particular promotional benefit being offered by the loyalty program in the department. Specific loyalty program information may also be downloaded to random terminals or at random intervals to create a lottery effect.

In accordance with the invention bonus point information is stored in the user device, eliminating any need to access a centralized location which stores point information to award and/or remove points. However, for security and/or purposes of monitoring the success of the loyalty program point award and redemption information may be communicated by merchant terminals to a centralized location, e.g., a store and/or regional server.

Examples of awards may be a fixed number of program points for each dollar of items purchased. Awarded points can be redeemed for items and/or discounts on purchases. For example, a set number of points could be redeemed for a free item. Another number of points could be redeemed to obtain a pre-determined percentage discount on the total purchase price of items being purchased.

The memory in merchant terminals used to store loyalty point information and/or the processor used to perform loyalty point calculations can, and in some embodiments are, implemented on a removable card. In such embodiments a store manager can, and in some embodiments does, update loyalty program information in individual terminals by replacing the card in a terminal which stores a set of loyalty program information. The replacement card may be loaded with the updated set of loyalty program information at the store's server and then manually inserted into the merchant terminal by the store manager to thereby update the individual merchant terminal without the need to connect the terminal being updated to the store or regional server.

Numerous additional advantages and embodiments of the methods and apparatus of the present invention are discussed in the detailed description which follows.

### DETAILED DESCRIPTION

The present invention is directed to methods and apparatus for implementing loyalty programs. Various embodiments of the invention are described in U.S. Provisional Patent Application Ser. No. 60/471,185, filed May 16, 2003 which is hereby expressly incorporated by reference.

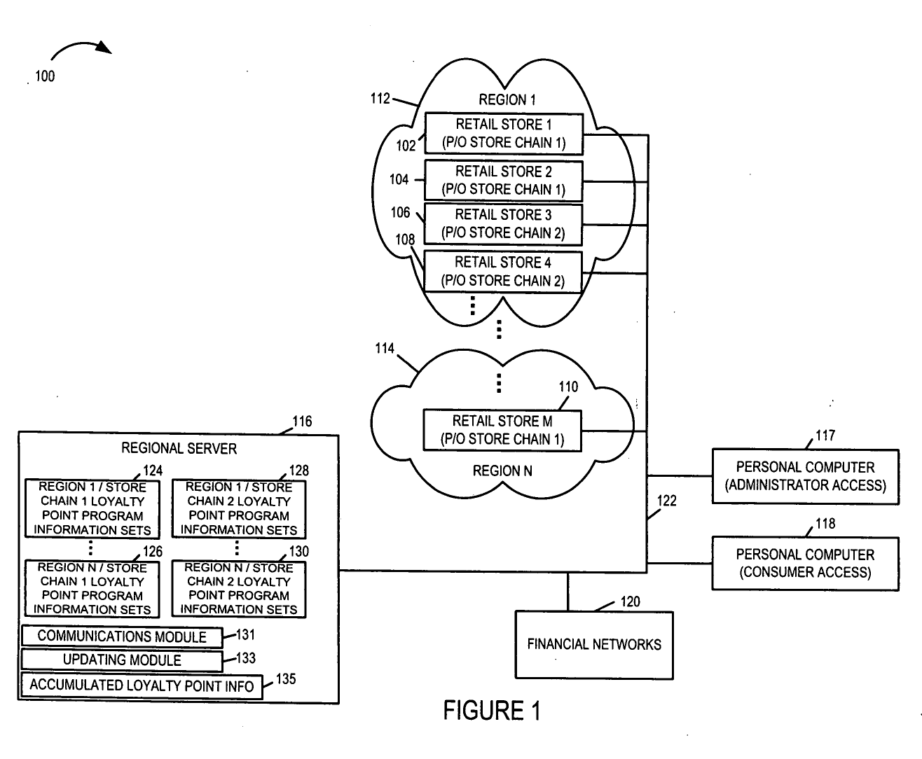

FIG. 1 of the present application illustrates an exemplary system 100 which implements a loyalty point program using portable user data storage devices, e.g., smart cards, in accordance with one exemplary embodiment of the invention. The smart cards can be read from and written to by one or more terminals located at various retail stores 102, 104, 106, 108, 110 which may be located in different regions.

While implemented using smart cards in many embodiments, the portable user data storage devices may be implemented in shapes other than cards, e.g., key chain devices. The user data storage devices normally include non-volatile memory for storing user information including the number of loyalty points which have been awarded, point award date information, and/or information identifying the user and how frequently the user has visited a particular merchant or made purchases from a particular merchant. The user data storage devices may interact with a merchant terminal through a magnetic, electrical or wireless connection. Thus, a merchant terminal including a user device interface can read from, and write to, a portable user data storage device being used by a customer making a purchase or seeking to redeem program points which have already been awarded.

Merchant terminals capable of reading and writing information to user smart cards are used to award points to customers based on a set of loyalty program information stored in the merchant terminal, at least some information read from the smart card, and information such as the purchase amount.

Multiple merchant terminals within a store may be programmed with the same set of loyalty point program information. Different loyalty point program awards may be specified for items corresponding to different store departments. Managers of individual departments may update the loyalty point program information corresponding to the individual department for which the manager is responsible. While terminals can be programmed to give different awards for purchases of different items and/or items corresponding to different departments, in some embodiments different terminals within a store are loaded with different loyalty program information allowing the program to be specific to a store department or location.

Updating of loyalty program information from a server facilitates implementation of rapid changes in plans allowing plans to be modified or an hourly basis if desired as part of a particular promotion in a department. Bonus point information is stored in the user device, eliminating any need to access a centralized location which stores point information to award and/or remove points.

The methods and apparatus of the present invention enable loyalty program information to be distributed and changed on merchant terminals through a connection to a back-end system, e.g., a store or regional server, used to distribute loyalty program information. In some embodiments a loyalty program administrator is allowed to log in to a server via a web interface to change the loyalty program parameters and select the date when the new loyalty program will take effect. The terminals in the merchant stores connect to the server on a periodic basis or in response to the server initiating contact as part of an update process. If an update is available for a contacted terminal or terminal contacting the server, the server sends the new set of loyalty program information intended for the terminal to the terminal, e.g., over a network connection.

Smart card loyalty programs implemented in accordance with the invention enable merchants to issue rewards to consumers based on consumer preferences or behavior. Since merchants may wish to reward different consumer preferences and behaviors over a period of time, e.g., as a function of how frequently the customer makes purchases from the merchant. The update process of the present invention facilitates implementation of an effective loyalty program by enabling the loyalty program to be updated and modified in merchant terminals during different points in time while the program is in effect facilitating short term promotions and special promotions at particular stores and/or departments within a store. This allows the merchant greater control and flexibility.

Loyalty programs implemented in various embodiments use information on the consumer's device, e.g., smart card, along with loyalty program information stored in the particular merchant terminal being used by the customer to make a purchase or redeem awarded loyalty points, in making loyalty point award and/or redemption determinations. With the redemption of previously awarded loyalty points, information indicating an updated count of awarded but unused loyalty points is normally written to the user's device which is used in the redemption process.

The set of loyalty program information stored in the terminal that is updated by a server in accordance with the present invention may include weights used to determine the number of points allocated given a total purchase amount, lists of items for which points are to be awarded, number of points to be awarded for purchase of a particular item, information on the loyalty point redemption such as items and/or discounts which may be provided for a particular number of loyalty points.

Updating of loyalty program information via a store based or regional server in accordance with the invention allows loyalty program information to be updated on an individual terminal basis as frequently as desired by the loyalty program administrator at any instant and/or on a periodic basis, e.g., on a minute by minute, hourly, daily or weekly basis. In various embodiments, the server used to update loyalty program information stores information on the dates/times a particular set of loyalty program information is to be used by a particular merchant terminal and then updates the particular terminal at the specified time or prior to the specified time so that the terminal can implement the new or modified plan at the intended time.

To simplify the update process, a merchant can create multiple sets of loyalty program information for a store with, e.g., each set of information corresponding to one or more departments in the store. The registers in the same departments of multiple stores may be updated using the same set of loyalty program information. In this manner a company owning a large chain of stores can easily update the loyalty program information in multiple stores from the same centralized, e.g., regional server. Alternatively, or in addition, different sets of loyalty plan information may be used for different regions.

In one exemplary embodiment where terminals are updated from a server within a store, the merchant terminals within the store are connected on a local network to the store's server and the store managers can change the loyalty program information on the store terminals as frequently as they wish by updating the set or sets of loyalty program information on the in store server which in turn updates individual store terminals, e.g., immediately or at a specified time. In another embodiment a regional server is located off-site and is used to update the sets of loyalty program information for a number of store locations. The regional server may do this by connecting to a store server and initiating an update through the store server or by connecting to the merchant terminals in a store directly, e.g., via a network such as the Internet or telephone lines.

In various embodiments the servers used to manage and update the loyalty programs are made accessible to management through a web site which allows loyalty program information to be reviewed and configured remotely. The updated loyalty program information can then be downloaded from the server to individual terminals as discussed above on a periodic and/or management specified basis.

The remote server based management approach to loyalty programs used in some embodiments has the advantage of allowing a third party to provide the hardware and/or software required to implement a loyalty program minimizing or eliminating the need for special hardware at the individual stores. Thus, the store owner can be involved and in control of the details of the loyalty program and bonus offered without having to be involved with having to manage the server and/or other hardware used to support the bonus program. In fact, the smart cards and/or other types of user devices used to implement the invention may be issued by the third party, e.g., a credit card provider, and not the store. Thus, the methods and apparatus of the present invention allow even small merchants with one or two stores to participate in loyalty programs, and/or create custom loyalty programs, without having to get involved in the hardware issues surrounding implementation of such programs. It should be appreciated that in some embodiments of the invention, regional servers serve multiple merchants, e.g., different store chains, owned by different individuals and/or companies and support different loyalty plans for the different merchants.

The methods and apparatus of the invention can be used in deploying a loyalty program in a wide variety of retail locations. Smart card point of sale (POS) terminals can be installed in the retail locations prior to the merchant setting up the loyalty program. In various embodiments the loyalty program administrator can then log on to the loyalty program management server through the website or the local store server and configure the loyalty program and corresponding loyalty program information to be downloaded to the individual store terminals. In various embodiments, the loyalty program administrator can select options such as double points issued on weekends or holidays, give a discount on certain items on a certain day or days of the week. In some exemplary implementations, the loyalty program administrator can also select to start the program on a certain day or immediately upon updating of one or more merchant terminals. Individual terminals within a retail store may receive specific loyalty program updates which differ from updates provided to other terminals in the store. An example would be for certain terminals in a specific department in a store to receive special loyal programs which are not offered at the terminals in other departments of the same store.

In embodiments where telephone connections are used to update merchant terminals, the merchant terminals may be configured to dial up a store or regional server on a periodic basis and check for new loyalty programs. If a new loyalty program exists it will be downloaded from the server to the merchant terminal.

While loyalty point information is stored on individual user devices, in various embodiments, information on the award, redemption and total number of outstanding points is maintained in central location, e.g., the regional server, and updated periodically from information obtained from individual merchant terminals, e.g., at the time the terminals are updated. In this manner, a merchant can track the success of different loyalty programs and adjust the programs in response to how users take advantage of such programs and/or which items a retailer wants to promote at a particular point in time.

While the information collected at the central location regarding the current number of outstanding loyalty points awarded to various program participants need not be accessed in order for a merchant terminal to redeem outstanding loyalty points, in the case of lost devices it provides a way for the program sponsor to be able to restore awarded points to a user in the case of a lost or defective device. In addition, it reduces the risk of fraud by maintaining information which is duplicative of the information maintained in individual user devices. Large discrepancies between the number of points indicated as having been awarded to a particular user in the central data base of the regional server and the number indicated by the information stored in the user device may be used to detect system errors and fraud, e.g., by comparing the two values and generating a fraud or error warning in the case of a discrepancy beyond some selected or predetermined threshold.

The server based control approach of the invention allows loyalty programs to be configured on a store level so different loyalty programs can be set up for different stores and/or on a merchant level so that multiple stores owned by a particular merchant are controlled by the same set or sets of loyalty plan information.

FIG. 1 is an exemplary system 100 for managing loyalty schemes implemented in accordance with the present invention and using methods of the present invention. FIG. 1 shows an exemplary system 100 includes a plurality of participating retail stores at different physical locations, retail store 1 102, retail store 2 104, retail store 3 106, retail store 4 108, and retail store M 110. At least two of the retail stores 102, 104, 106, 108, 110 belong to different retail chains, for example, different retail chains with different owners. In exemplary system 100, retail store 1 102, retail store 2 104, and retail store M 110 belong to store chain 1, while retail store 3 106 and retail store 4 108 belong to store chain 2. The system 100 is also divided into a plurality of regions, e.g., geographic regions, region 1 112, region N 114. The different regions may correspond to different states or even different countries. Retail stores 102, 104, 106, 108 are part of region 1 112, while retail store M 110 is part of region N 114. System 100 also includes a regional server 116, a plurality of personal computers 117, 118, and financial networks 120. The retail stores (102, 104, 106, 108, 110), regional server 116, personal computers (117, 118), and financial networks 120 are coupled together via network 122 over which the various elements may interchange data and information. Network 122 may represent the telephone network and communications on the network 122 may be, e.g., via the IP packets.

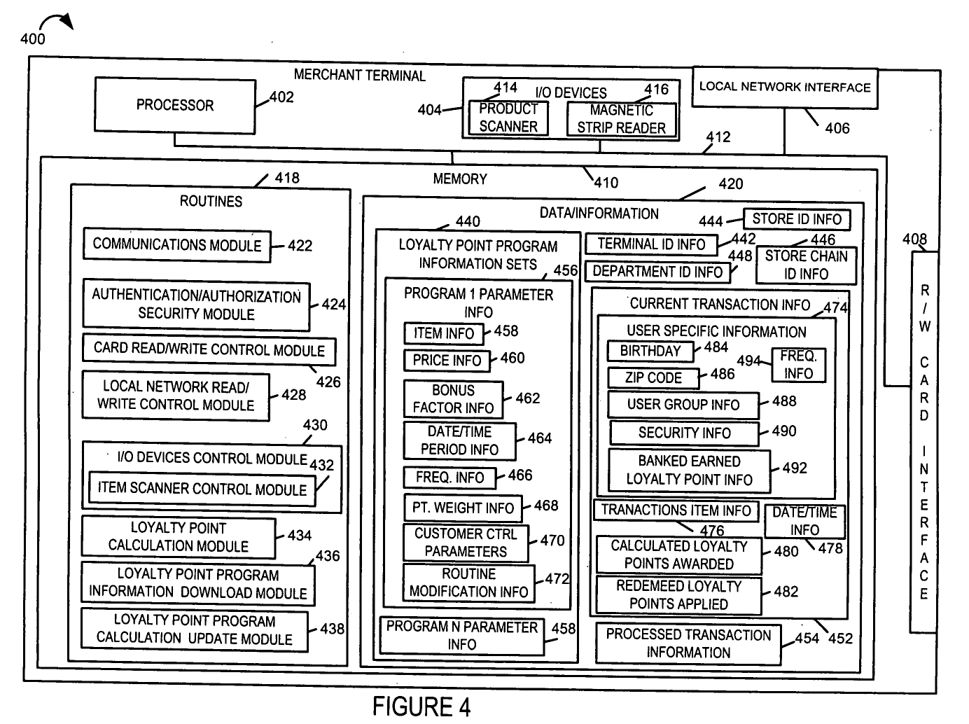

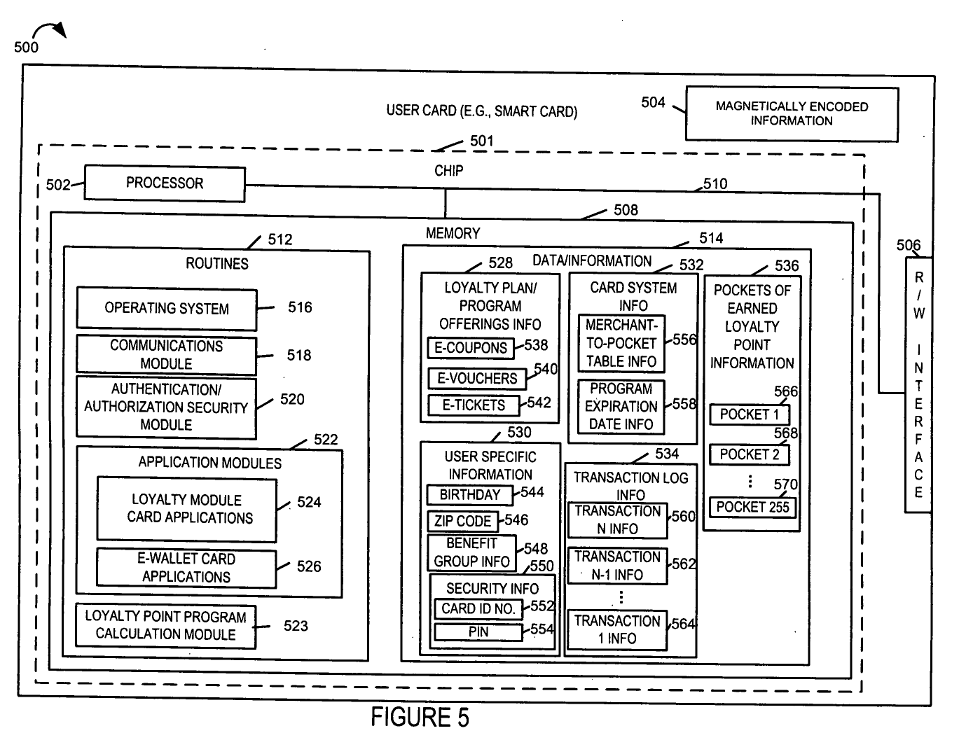

The regional server 116 manages the loyalty plan in participating stores (102, 104, 106, 108, 110) in geographic regions (112, 114), respectively. Regional server 116 is located remotely from at least some of the retail stores (102, 104, 106, 108, 110). The regional server 116 includes a plurality of point program information sets for each region, region 1/store chain 1 loyalty point program information sets 124, region N/store chain 1 loyalty point program information sets 126, region 1/store chain 2 loyalty point program information sets 128, region N/store chain 2 loyalty point program information sets 130. Region server 116 also includes communications module 131 which enable the communication of the loyalty point information sets (124, 126, 128, 130) to the appropriate retail stores corresponding to the region and store chain to which the store belongs and allows the server 116 to receive information from the retail stores. Regional server 116 also includes a loyalty point program information updating module 133 which coordinates scheduling for the transmission of loyalty point program information sets (124, 126, 128, 130). Regional server 116 also includes accumulated loyalty point information 135, which serves as a central data repository for information regarding awarding, redemption, and total numbers of outstanding loyalty points. Accumulated loyalty point information 135 is maintained in regional server 116 and updated periodically from information obtained from individual merchant terminals 400 (see FIG. 4), e.g., at the time terminals 400 are updated. In this manner, a merchant can track the success of different loyalty programs and adjust the programs in response to how the users take advantage of such programs and/or which items a retailer wants to promote at a particular point in time. Terminals 400 need not access, and generally do not access, the centrally located accumulated loyalty point information 135 at the time of redemption, as individual user cards 500 (see FIG. 5) store an individuals accrued loyalty point information. Maintaining this duplicate set of accumulated loyalty point information 135 in a central location allows for the replacement of lost user cards 500 with accumulated points stored thereon and allows for tracking consistency checks thereby reducing the risk of fraud which might occur absent from some point tracking outside user devices.

Personal computer 117 is used as an administrative access point for managing the loyalty point retail system 100. A plurality of personal computers 117 may exist, e.g., at different locations to accommodate different administrators. A regional administrator, with the appropriate authorization access level can access the server 116, e.g., via a Web interface and the Internet, enter new loyalty point information, and modify the loyalty point information sets 124, 126, 128, 130 which reside in the regional server 116. The regional administrator can also perform system configuration changes, e.g., adding a new participating store, and conveying the change information to the regional server 116 through personal computer 117. Personal computer 117 is also used by a local administrator, e.g., a store manager with the appropriate authorization access level, to change, e.g., via a Web browser interface, loyalty point program information residing within the managed store, e.g., adding a one day bonus point special to apply to a low selling item. Personal computer 118, e.g., a store computer or cardholder's home computer including a card interface device, allows a cardholder to view loyalty plan information stored on the cardholder's card, view loyalty plan options and policies, e.g., at a store's Web site, sign-up to be a member of loyalty plan groups, and/or download E-coupons. Financial networks 120, e.g., existing credit card/debit card financial networks, may be used to authenticate the card using existing protocols when making credit/debit purchases at merchant stores, e.g., retail store 102. This can occur in embodiments where the card is issued along with a credit or debit application.

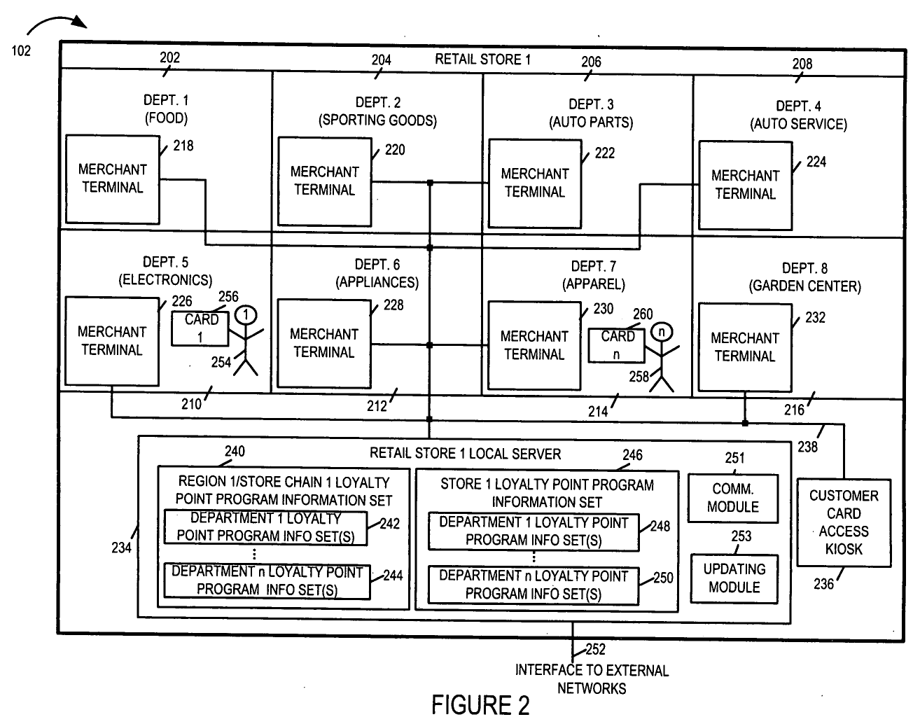

FIG. 2 is a drawing of the exemplary retail store 1 102 shown in FIG. 1. Exemplary retail store 1 102 is implemented in accordance with the present invention and uses methods of the present invention. Retail store 1 102 includes a plurality of departments 202, 204, 206, 208, 210, 212, 214, 216, each department is normally situated in a different location within retail store 1 102.

Exemplary department 1 202 is a food department and includes a merchant terminal 218. Department 2 204 is a sporting goods department and includes a merchant terminal 220. Department 3 206 is an auto parts department and includes a merchant terminal 222. Department 4 208 is an auto service department and includes merchant terminal 224. Department 5 is an electronics department 210 and includes merchant terminal 226. Department 6 is an appliances departments 212 and includes a merchant terminal 228. Department 7 is an apparel department 214 and includes a merchant terminal 230. Department 8 is a garden center department and includes a merchant terminal 232. Each merchant terminal, e.g., merchant terminal 226, may include a store and/or department specific set of loyalty point information used in calculating and awarding loyalty points for purchases made at the merchant terminal in the particular department.

Retail store 1 102 also includes a retail store 1 local server 234 and a customer card access kiosk 236. Merchant terminals (218, 220, 222, 224, 226, 228, 230, 232), local server 234, and kiosk 236 are coupled together via a local, e.g., intra-store, network 238 over which the various elements may interchange data and information. The network 238 may be a wireless network.

Local server 234 includes a region 1 store/store chain 1 loyalty point program information set 240 which is a local copy of the applicable loyalty point information most recently communicated from the regional server 116, e.g., information set 124. Region 1/store chain 1 loyalty point program information set 240 includes a plurality of loyalty point program information sets. In cases where terminals in different departments are loaded with different loyalty program information, each set may correspond to a different department within the store, department 1 loyalty point program information set(s) 242, department n loyalty point program information set(s) 244. Local server 234 also includes store 1 loyalty point program information set 246 including a plurality of loyalty point information sets corresponding to different departments within the store in the case where terminals in different departments are loaded with different sets of loyalty plan information. In the example, local server 234 includes department 1 loyalty point program information set(s) 248, department n loyalty point program information set(s) 250. Store 1 loyalty point program information set 246 is based on a copy of region 1/store chain 1 loyalty point program information set 240, but includes additional modifications to the program tailored, e.g., by a store 1 manager. For example, store 1 loyalty point program information set 246 may accommodate unique promotions within store 1 102, e.g., a locally advertised two day triple bonus point special within the sporting goods department applying to baseball equipment, promoted near the end of the baseball season, to sell a large excess stock of remaining merchandise from the shelves of retail store 1 102. Each department loyalty point information set 248, 250 is communicated to the respective department and loaded into the respective merchant terminal. For example, department 1 loyalty point information set 248 is loaded into merchant terminal 218 in the food department 202.

Local server 234 also includes communications module 251 which allows the local server 234 to receive communicated loyalty point information sets 242, 244 from the regional server 116, and also allows server 234 to transmit and communicate the loyalty point program information sets 248, 250 to the appropriate departments. Local server 234 also includes a loyalty point program information updating module 253 which coordinates scheduling for reception of loyalty point program information sets 242, 244 and the transmission of loyalty point program information sets 248, 250. In some embodiments the local server 234 is operated to update merchant terminals 218, 220, 222, 224, 226, 228, 230, 232, with loyalty point program information updates on a predetermined schedule. Different departments may have different updating schedules. In some embodiments, at least some merchant terminals are updated with loyalty point program information multiple times in a single day, e.g., for different effective time periods with the day, some of the time periods lasting less than 3 hours in duration.

Interface 252 couples retail store 1 local server 234 via bus 122 to external networks, e.g., the Internet and/or private network(s), allowing the exchange of information, e.g., loyalty point program information, transaction information, update information, feedback information, etc., between local server 234 and regional server 116, personal computers 117, 118, and/or financial networks 120 (see FIG. 1).

Retail store 1 102 also includes two exemplary customers, customer 1 254, customer n 258. Customer 1 254, situated in (electronics) department 5 210 and possesses a first user card, card 1 256. Customer 254 may use this card 256 to make a purchase. Card 1 256 is coupled to merchant terminal 226 and interchanges information with merchant terminal 226 regarding loyalty points related to the purchase, and optionally is used to pay for the purchase. The card interface with the merchant terminal may be a wireless interface which uses radio signals to receive and transmit information. Similarly, customer n 258, situated in (apparel) department 7 214 and possessing a user card, card n 260, is making a purchase. Card n 260 is coupled to merchant terminal 230, interchanges information with merchant terminal 230 regarding loyalty points related to the purchase, and optionally is used to pay for the purchase.

Customer card access kiosk 236 located at any convenient point within store 1 102, interfaces with customer cards 256, 260. The kiosk 236 allows customers 254, 258 to view the information, e.g., accrued loyalty points, group memberships, etc., stored on their card 256, 260. Kiosk 236 also allows customers 254, 258 to sign-up and store additional loyal plan offerings, e.g., download electronic coupons, join special groups, e.g., a baby club group offering special discounts on infant related apparel items. In addition, kiosk 236 allows customers 254, 258 to view time windows and expiration information relating to various loyalty point programs. Kiosk 236 also allows a customer 254, 258 to find out in-advance, whether the purchase of a specific item would accrue any loyalty points, and if so how many points would be awarded and any restrictions on the points, e.g., if they are non-transferable and must be used in the specific department in which they were awarded.

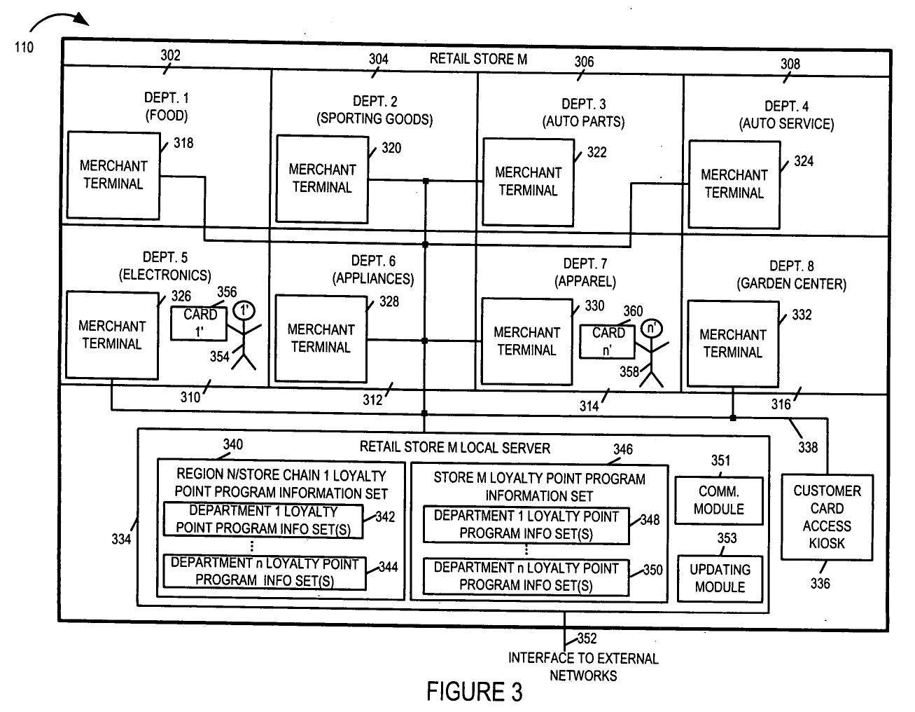

FIG. 3 is a drawing of the exemplary retail store M 110 shown in FIG. 1. Exemplary retail store M 110 is implemented in accordance with the present invention and uses methods of the present invention. Retail store M 110 includes a plurality of departments 302, 304, 306, 308, 310, 312, 314, 316, each department situated in a different location within retail store M 110.

Each department (302, 304, 306, 308, 310, 312, 314, 316) of store M 110 includes a merchant terminal (318, 320, 322, 324, 326, 328, 330, 332), respectively, and is similar to each department (202, 204, 206, 208, 210, 212, 214, 216) of store 1 102 and is not described in further detail. In this example, each merchant terminal, e.g., merchant terminal 326, includes a department specific set of loyalty point information used in calculating and awarding loyalty points for purchases made within the department at the department merchant terminal. However, in other embodiments, as discussed above, it is possible for the terminals in different departments to be loaded with the same set of loyalty program information with the information indicating different treatment in terms of awards and/or discounts, for items corresponding to different departments.

Retail store M 110 also includes a retail store M local server 334 and a customer card access kiosk 336. Merchant terminals (318, 320, 322, 324, 326, 328, 330, 332), local server 334, and kiosk 336 are coupled together via a local, e.g., intra-store, network 338 over which the various elements may interchange data and information.

Local server 334 includes a region N store/store chain 1 loyalty point program information set 340 which is a local copy of the applicable loyalty point information most recently communicated from the regional server 116, e.g., information set 126. Region N/store chain 1 loyalty point program information set 340 includes a plurality of loyalty point program information sets, each set corresponding to a different department within the store, department 1 loyalty point program information set(s) 342, department n loyalty point program information set(s) 344. Local server 334 also includes store M loyalty point program information set 346 including a plurality of loyalty point information sets corresponding to different departments within the store, department 1 loyalty point program information set(s) 348, department n loyalty point program information set(s) 350. Store M loyalty point program information set 346 is based on a copy of region N/store chain 1 loyalty point program information set 340, but includes additional modifications to the program tailored, e.g., by a store M manager. For example, store M loyalty point program information set 346 may accommodate unique promotions within store M 110, e.g., an end of day bonus point special within the food department applying to store baked doughnuts, rolls, and bagels. Each department loyalty point information set 348, 350 is communicated to the respective department and loaded into the respective merchant terminal. For example, department 1 loyalty point information set 348 is loaded into merchant terminal 318 in the food department, department 1 302.

Local server 334 also includes a communications module 351 and an updating module 353, which are similar or identical to modules 251, 253, respectively, which have already been described with respect to FIG. 2 and shall not be further discussed.

Retail store M 110 also includes two exemplary customers, customer 1′ 354, customer n′ 358. Customer 1′ 354, situated in (electronics) department 5 310 and possessing a user card, card 1′ 356, is making a purchase. Card 1′ 356 is coupled to merchant terminal 326, interchanges information with merchant terminal 326 regarding loyalty points related to the purchase, and optionally is used to pay for the purchase. Similarly, customer n′ 358, situated in (apparel) department 7 314 and possessing a user card, card n′ 360, is making a purchase. Card n′ 360 is coupled to merchant terminal 330, interchanges information with merchant terminal 330 regarding loyalty points related to the purchase, and optionally is used to pay for the purchase.

Customer card access kiosk 336, located at any convenient point within store M 110, interfaces with customer cards 356, 360. Kiosk 336 is similar or identical to kiosk 236 in store 1 102 and is thus not described in further detail. Retail store M 110 also includes an interface to external networks 352 which is the same or similar to interface 252 already described with respect to store 1 102 and thus is not further described.

FIG. 4 is a drawing of an exemplary merchant terminal 400 implemented in accordance with the present invention and using methods of the present invention. Exemplary merchant terminal 400 is a detailed representation of any of the exemplary merchant terminals used in system 100, e.g., merchant terminals (218, 220, 222, 224, 226, 228, 230, 232) of FIG. 2 or merchant terminals (318, 320, 322, 324, 326, 328, 330, 332) of FIG. 3. Merchant terminal 400 includes a processor 402, I/O devices 404, local network interface 406, a read/write card interface 408, and a memory 410 coupled together via bus 412 over which the various elements may interchange data/information. Memory 410 includes routines 418 and data/information 420.

The processor 402, e.g., a CPU, executes the routines 418 and uses the data/information 420 to control the operation of the merchant terminal 400 and implement the methods of the invention, including loyal point related functions in accordance with the present invention. I/O devices 404 includes a product scanner 414 for scanning information, e.g., bar codes or RFIDs (Radio Frequency IDs), on items being purchased at merchant terminal 400, thus identifying the purchase item. I/O devices 404 also includes a magnetic strip reader 416 used to read magnetic strip information, e.g., credit/debit card information, obtained from a user card, e.g., user card 500 (see FIG. 5), such obtained information may be used and conveyed to financial networks 120 in the purchase transaction to pay for the item. The magnetic strip reader 416 may be used in addition to a read/write card interface 408. Local network interface 406 provides an interface for coupling the merchant terminal 400 to a local network, e.g., network 238, 338, thus coupling the merchant terminal 400 to a local store server, e.g., server 234, 334. Read/write card interface 408, e.g., a wireless interface and/or an electrical receptacle with interface circuitry and buffers, provides an interface to couple a user card 500 to the merchant terminal 400 allowing the interchange of data/information, e.g., user specific information, loyalty points awarded and redeemed, transaction log information, etc., between merchant terminal 400 and user card 500.

Routines 418 include a communications module 422, an authentication/authorization security module 424, a card read/write control module 426, a local network read/write control module 428, an I/O devices control module 430, a loyalty point calculation module 434, a loyalty point program information download module, and a loyalty point program calculation update module 438. Data information 420 includes loyalty point program information sets 440, terminal identification information 442, store identification information 444, store chain identification information 446, department identification information 448, current transaction information 452 and processed transaction information 454.

Loyalty point program information sets 440 includes a plurality of loyalty point program parameter information, program 1 parameter information 456, program N parameter information 458. Program 1 parameter information 456 includes item information 458, price information 460, bonus factor information 462, date/time period information 464, frequency information 466, point weight information 468, customer control parameters 470, and routine modification information 472. Item information 458 includes a list of items that may be purchased in the department in which merchant terminal 400 is located, to which loyalty points may be accrued. Price information 460 includes information adjusting the amount of loyalty points relative the purchase price, e.g., a specific amount of points awarded in proportion to the purchase price, specific numbers of loyalty points awarded for exceeding threshold price levels, etc. Bonus factor information 462 includes information relating to special offerings, e.g., where the number of loyalty points awarded is double, triple, etc., the amount normally awarded such as during a special advertised sale. Bonus factor information 462 also includes information relating to using special days, e.g., a customer's birthday, to award extra loyalty points for purchases made on that day, and information relating to random grants, e.g., a lucky customer receives a number of loyalty points. Date/time period information 464 includes information defining expiration dates on existing programs and/or portions of programs, e.g., a program ends on December 25. Date/time period information 464 also includes information indicating time periods, e.g., 7 A.M-10 A.M., in which loyalty point program information should be used for accruing loyalty points, and expiration dates by which certain accrued loyalty points must be redeemed or will be forfeited. Frequency information 466 includes information related to factoring the award of loyalty points on the basis of the frequency of the user making a purchase in the chain, particular store, and/or particular department, e.g., as a consumer becomes more loyal by making more frequent purchases the consumer can be awarded by receiving loyalty points at a higher factors. Point weight information 468 includes factors relating accrued loyalty points to specific monetary redemption values usable toward future purchases, amounts of discounts to be given for a number of points, etc. Customer control parameters 470 defines which customer information obtained from the user card, e.g., birthday 484, are used in calculating loyalty points. Routine modification information 472 includes information that is used by the loyalty point program calculation update module 438 to alter, update, adjust and/or replace the loyalty point calculation module 434. Points may be awarded and accrued on a per store department basis in some embodiments with the user device storing multiple accrued point values corresponding to different departments of a store.

Terminal identification information 442 includes a serial number that uniquely identifies terminal 400 in system 100 and access numbers, e.g., administrative PIN numbers, associated with terminal 400. Store identification information 444 includes information, e.g., a store ZIP code, address, etc., that uniquely identifies the store in which merchant terminal 400 is located from a plurality of similar stores in a chain of stores. Store chain identification information 446 includes information that associates terminal 400 with one chain of stores from among a plurality of chains of stores within system 100. Department identification information 448 includes information, e.g., codes, that associate terminal 400 with a specific department, e.g., food, sporting goods, etc., in which merchant terminal 400 is located.

Current transaction information 452 includes information related to a current purchase at merchant terminal 400. Current transaction information 474 includes user specific information 474, transaction item information 476, date/time information 478, calculated loyalty points awarded 480, and redeemed loyalty points applied 482. User specific information 474 includes information obtained from the customer's user card 500 which may be used in the calculation of loyalty points related to the current transaction. User specific information 474 includes, e.g., a birthday 484, a zip code 486, user group information 488, security information 490, banked loyalty point information 492, and frequency information 494, e.g., information indicating the frequency and/or average amount of purchases in a particular store or store department. Birthday information 484 provides the birthday of the card user. Birthday information 484 may be used, e.g., to adjust the loyalty point calculation to provide a one day special rate on the cardholder's birthday, to categorize the user by age, e.g. classifying the user a senior citizen and providing a senior citizen loyalty point rate, and/or to tailor E-coupons by user age. Zip code 486 is the zip code of the cardholder. Zip code 486 may be used, e.g., to adjust loyalty points awarded based upon the distance of the cardholder from the store to partially compensate a cardholder for gasoline cost and/or to provide greater incentives for users living relatively far away than those close to the store. Zip code 486 may also be used to structure loyalty points so as to influence cardholders located close to a competitor to travel the extra distance to make a purchase at merchant terminal 400 instead of at the competitor. User group information 488 includes information identifying groups to which the cardholder belongs, e.g., different groups associated with different loyalty point awarding policies. In some groups, membership may be free and just require the cardholder to sign-up, e.g., provide some personal identification and/or demographic information that may be used for tracking. In other groups, membership may require a fee, and there may be different fees associated with different tiers and policies, e.g., a premier membership, a gold membership, a silver membership. In some embodiments, membership may be associated with a financial institution and/or a credit/debit card. Security information 490 includes information to securely associate the cardholder with the card 500, e.g., a PIN, a biometric parameter, etc., information to authenticate the card, and information to authenticate the loyalty points recorded on the card. Banked earned loyalty point information 492 includes loyalty points from previous transactions stored on card 500 that have not been redeemed and information associated with those loyalty points, e.g., any restrictions such as a limit requiring those points to be redeemed toward merchandise in the same department in the same store by a certain expiration date. Frequency information 494 includes information indicating the frequency of prior visits and/or purchases to a store chain, a specific store, a department in the store chain, and/or a department in a specific store. Such information 494 may be used in calculating the number of loyalty points awarded to the customer.

Transaction item information 476 includes information identifying the item to be purchased at merchant terminal 400 and identifying the price associated with the item. Data/time information 478 is the current date and time of the transaction. The current date/time information 478 may be used in the calculation of loyalty points, as some programs are time/date sensitive, and in the redemption of loyalty points, as some loyalty points expire if not redeemed by their expiration date. Calculated loyalty points awarded 480 includes information specifying the number, type and/or restriction with loyalty points to be awarded with respect to the current purchase. Redeemed loyalty points applied 482 includes information specifying the number of loyalty points to be applied, e.g., as a reduction in price, for the current purchase. In some embodiments, calculated loyalty points awarded 480 can be directly applied in the current transaction as redeemed loyalty points awarded. In some embodiments, redeemed loyalty points applied 482 may include loyalty points from banked earned loyalty points 492, but does not include calculated loyalty points awarded 480.

Processed transaction information 454 includes a set of information pertaining to the current transaction at merchant terminal 400. At the completion of the transaction, such processed transaction information 454 or portions of such information are transferred to the user card 500 to be stored in a log. Processed transaction information 454 may also be transferred to the local server 234, 334 and/or regional server 116 for compilation, processing, and trend analysis of the loyalty point programs.

Communications module 422 supports and enables the various communications protocols used by merchant terminal 400. Authentication/authorization and security module 424 uses the data information 420 including security information 490, information obtained from magnetic strip reader 416, and any security information, e.g., PIN, input to merchant terminal 400 to authenticate the user card 500 to the purchaser, to authenticate the loyalty points stored on the card, to authenticate the credit/debit card with a financial network, and/or to verify that the credit/debit card is valid for monetary amount required for the purchase. In some embodiments, the financial network may also serve as the issuer of the smart cards used by individual users and can therefore authenticate the device and/or specific loyalty program membership in addition to credit/debit information. Card read/write control module 426 controls the operation of the read/write card interface 408 to control the transfer of user specific information 474 from user card 500 to merchant terminal 400, to transfer information from calculated loyalty points awarded 480 and redeemed loyalty points applied 482 to user card 500, and to transfer information included in processed transaction information 454 to user card 500 to be stored in a transaction log.

I/O devices control module 430 controls operation of I/O devices 404 including displays, keyboards, keypads, scanners, readers, keypads, touchpads, speakers, voice interfaces, electronic registers, printers, etc., used by merchant terminal 400. I/O control module 430 includes an item scanner control module 432. Item scanner control module 432 controls operation of product scanner 414 identifying the item being purchased and obtaining transaction item information 476. The identified item is compared to a list of items in item information 458 to identify if the purchased item is within the set of items to which loyalty points apply at merchant terminal 400.

Loyalty point calculation module 434 calculates loyalty points as a function of data/information 420 included in memory 410 including information included in loyalty point program information sets 456, 458 user specific information 474, transaction item information 476, and date/time information 478, in accordance with the present invention. The loyalty point calculation module 434 may be different for different merchant terminals 400, e.g., different calculation modules for different departments.

Loyalty point program information download module 436 controls the transfer and/or updates of loyalty point program information sets 440. Loyalty point program information download module 436 uses terminal ID information 442, store ID info 444, store chain ID info 446, and/or department ID information 448 in selecting information to be downloaded from a plurality of potential loyalty point program information sets that may be loaded from the local server, e.g., store 1 local server 234 and/or the regional server 116. In some embodiments, the loyalty point program information download module 436 operates to receive updates on a predetermined schedule. In some embodiments, the loyalty point program information download module 436 operates to receive updates multiple times in a single day, to implement loyalty point programs which are effective during different time periods of the day, some of the time periods can last less than three hours in duration.

Loyalty point program calculation update module 438 uses the downloaded routine modification information 472 to modify the loyalty point calculation module 434. For example, the loyalty point calculation module 434 may be altered such that for the same set of data/information input values, a different number of loyalty points will be awarded. In this way, changes to loyalty point programs can be implemented by changes to the calculation module 434, in place of or in addition to, changes to system control variables in information 456 such as item info 458, price info 460, bonus factor info 462, date/time period info 464, frequency info 466, point weight info 468, and customer control parameters 470.

FIG. 5 is a drawing of an exemplary user card 500, e.g., smart card, implemented in accordance with the present invention and using methods of the present invention. User card 500 is a standard plastic payment card, credit or debit, with an embedded smart card chip 501. The smart card chip 501 includes a processor 502 and memory 508. Exemplary user card 500 may be any of the user cards 256, 260 of FIG. 2 or user cards 356, 360 of FIG. 3. User card 500 includes the processor 502, a read/write interface 506, and the memory 508 coupled together via a bus 510 over which the various elements may interchange data and information. User card 500 also includes magnetically encoded information 504, e.g., identification and security information typically encoded on a standard credit/debit card used for financial transactions. Read/write card interface 506, e.g., an electrical interface including a connector that can be mated with merchant terminal read/write card interface 408, provides an interface to couple user card 500 to the merchant terminal 400 thus allowing the interchange of data/information, e.g., user specific information, loyalty points awarded and redeemed, transaction log information, etc., between merchant terminal 400 and user card 500. While read/write card interface 506 has been described for a wired connection interface, in some embodiments read/write card interface may be a wireless interface or a magnetic interface.

Memory 508 includes routines 512 and data/information 514. Processor 502, e.g., a CPU, executes the routines 512 and uses the data/information 514 in memory 508 to control the operation of the user card 500 and implement the methods of the present invention. At least a portion of the memory 510 is non-volatile.

Routines 512 include an operating system 516, a communications module 518, an authentication/authorization security module 520, and applications module 522. The applications modules 522 include a loyalty module 524 and E-wallet card applications 526.

Data/information 514 includes loyalty plan/program offering information 528, user specific information 530, card system information 532, transaction log information 534, and pockets of earned loyalty point information 536.

Loyalty plan/program offering information 528 includes E-coupons 538, E-vouchers 540, and E-tickets 542. E-coupons 538, an electronic version of a coupon, include information specifying loyalty points that are granted to the consumer if a specified item is purchased before an expiration date. There may be manufacturer, store chain, store, and/or department specific E-coupons 538. E-coupons 538 may be accumulated, e.g., by access from a customer card access kiosk, e.g., kiosk 236, 336. In addition a merchant terminal 400 may deposit an E-coupon 538 on user card 500 when a purchase is made at merchant terminal 400. For example, if a user purchases a DVD player at merchant terminal 326, the merchant terminal 326 may generate an E-coupon toward the future purchase of DVDs in the same department 310 of the same store 110.

E-vouchers 540, electronic vouchers, each voucher representing a fixed number of loyalty points, each point representing a fixed monetary value, that may be applied to any future purchase, e.g., within a particular time window, in a particular department, store, and/or store chain. E-vouchers 540 may be awarded to a customer and placed on card 500 at the time of a purchase to entice the customer to return to the store.

E-tickets 542, electronic tickets, include airline ticket information, movie, museum, theater, and/or sporting event ticket information. E-ticket 542 may be stored on user card 500 and accessed for admission. In addition, the loyalty programs may award E-tickets based on accrued loyalty points, e.g., an E-ticket to a movie may be obtained after accumulating a certain amount of loyalty points purchasing DVDs.

User specific information 530 includes a birthday 544 of the cardholder, a zip code 546 corresponding to the home address of the cardholder, benefit group information 548 including information indicating to which groups the cardholder belongs, and security information 550 used to authenticate the user card 500. Security information 550 includes a card identification number 552, and a personal identification number (PIN) 554. The user specific information 530 or portions of the user specific information are communicated to the merchant terminal 400 through read/write interface 506 for use in calculating loyalty points. Card system information 532 includes merchant-to-pocket table information 556 and program expiration date information 558. Merchant-to-pocket table information 556 includes information identifying each of the various pockets of stored loyalty point information 566, 568, 570 with a specific store chain, department, specific store, and/or department in a specific store. Program expiration information 558 includes information identifying various expiration data associated with various loyalty programs and/or information including expiration dates associated with various groups identified in benefit group information 548 to which the cardholder belongs.

Transaction log information 534 includes a plurality of the N most recent transactions, transaction log N information 560, transaction log N−1 information 562, transaction log 1 information 564. Each transaction log information set 560, 562, 564, represents a transaction result, e.g. with a merchant terminal 400. Log information 560, 562, 564 tracks recent changes and failed transactions.

Memory 536 corresponding to pockets of earned loyalty point information includes a plurality of sets of point information referred to as pockets, e.g., 255 pockets: pocket 1 566, pocket 2 568, . . . , pocket 255 570. Each pocket, e.g., pocket 1 566 includes information, e.g., special counters that are designated to store loyalty points that have been accrued. Each pocket 566, 568, 570 may correspond to a different category of loyalty points, e.g., loyalty points specific to a chain, store, department, etc. In some embodiments, the pockets of earned loyalty points 566, 568, 570 are updated by the merchant terminal during a transaction, e.g., adding additional loyalty points for a new purchase or removing accrued loyalty points during a redemption transaction. In other embodiments, loyalty point program calculation module 523 uses information communicated from the merchant terminal 400 to adjust the balances in each of the pockets 566, 568, 570.

Operating system 516 allows multiple applications to reside on, and be executed by, the chip 501 simultaneously. Communications module 518 is responsible for the various communications protocols used by card 500. Authentication/authorization security module 520 user the data/information 514 including security information 550 in conjunction with a merchant terminal 400 to authenticate the presenter of the card as the cardholder, to authorize a transaction, and/or to authenticate the information, e.g., loyalty points stored on the card 500.

Loyalty module 524, e.g., a multi-function card application, is a flexible application that provides for the loyalty functions to interface with the data/information 514. E-wallet (electronic wallet) applications 526 process electronic funds transfers, e.g., electronic payment and credits, processed through user card 500. Such electronic funds transfer may be independent and/or in conjunction with loyalty program operations. Loyalty point program calculation module 523, when employed, performs calculations for loyalty points, e.g., for a purchase transaction, in place of or in conjunction with loyalty point calculation module 434 in merchant terminal 400. In some embodiments, using loyalty point calculation module 523, information from loyalty point information sets 440, e.g., a portion of program 1 parameter info 456 and transaction item information 476 is transferred from merchant terminal 400 to be used with user specific information 530 in calculating and awarding loyalty points.

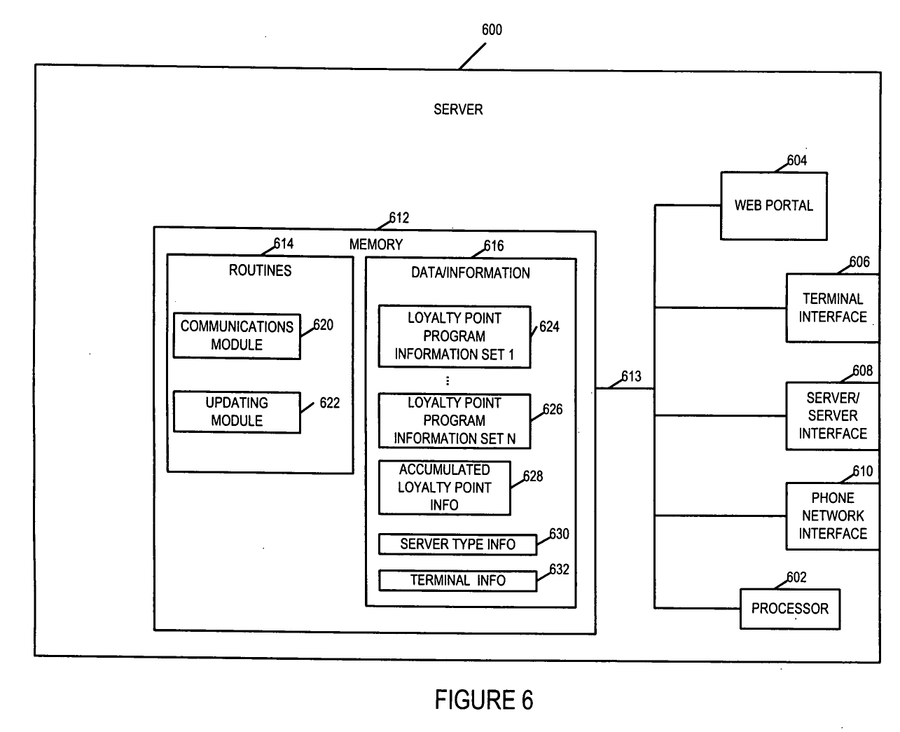

FIG. 6 is a drawing of an exemplary server 600 implemented in accordance with the invention and using methods of the present invention. Exemplary server 600 may be any of the exemplary servers (116, 234, 334) of FIGS. (1, 2, 3), respectively. Exemplary server 600 includes a processor 602, a web portal 604, a terminal interface 606, a server/server interface 608, a phone network interface 610, and memory 612 coupled together via bus 613 over which the various elements may interchange data/information. The memory 612 includes routines 614 and data/information 616. The routines 614 include a communication module 620 and an updating module 622. The data/information 616 includes a plurality of loyalty point program information sets: loyalty point program information set 1 624, loyalty point program information set N 626, accumulated loyalty point information 628, server type information 630, and terminal information 632.

The processor, e.g., a CPU, executes the routines 614 and uses the data/information 616 in memory 612 to control the operation of the server 600 and implement the methods of the invention. Web portal 604 is used for Internet communications, e.g., system administrators modifying loyalty point information sets 624, 626, accessing accumulated loyalty point information 628, and changing updating schedules. Terminal interface 606 is used an interface to merchant terminals 400, e.g., coupling server 600 to a plurality of department merchant terminals via a local bus, e.g., bus 238, 338. Server/server interface 608 is an interface used to couple a regional server 116 to a local server 234, 334. Phone network interface 610 is an interface, e.g., a modem, used to couple server 600 to a phone network or other communications network such as a cable communications network or wireless communications network. In some embodiments, various interfaces 606, 608, and/or 610 may be implemented as a combined interface.

Communications module 620 implements the various protocols used by server 600. Communications module 620 provides means to communicate the loyalty point information sets 624, 626, e.g., between servers 600 and/or between servers 600 and merchant terminals 400, and to receive information. Updating module 622 coordinates scheduling for the reception, transmission, and updating of loyalty point program information sets. Updating module 622 also updates information sets 624, 626 based on information received, e.g., from an administrator. Loyalty point program information sets 624, 626 may include sets pertaining to regions, store chains, stores, and/or departments. Accumulated loyalty point information 135 is a data repository for information regarding awarding, redemption, and total numbers of outstanding loyalty points. Server type information 630 includes information pertaining to server 600, such as information classifying server 600 as a regional server, local server, store server and information pertaining to operation of server 600, e.g., information used by the interfaces 606, 608, 610. Terminal information 632 includes information on the various merchant terminals, that may be coupled either directly or indirectly, to server 600, e.g., information identifying the terminal by store, chain, department, etc.

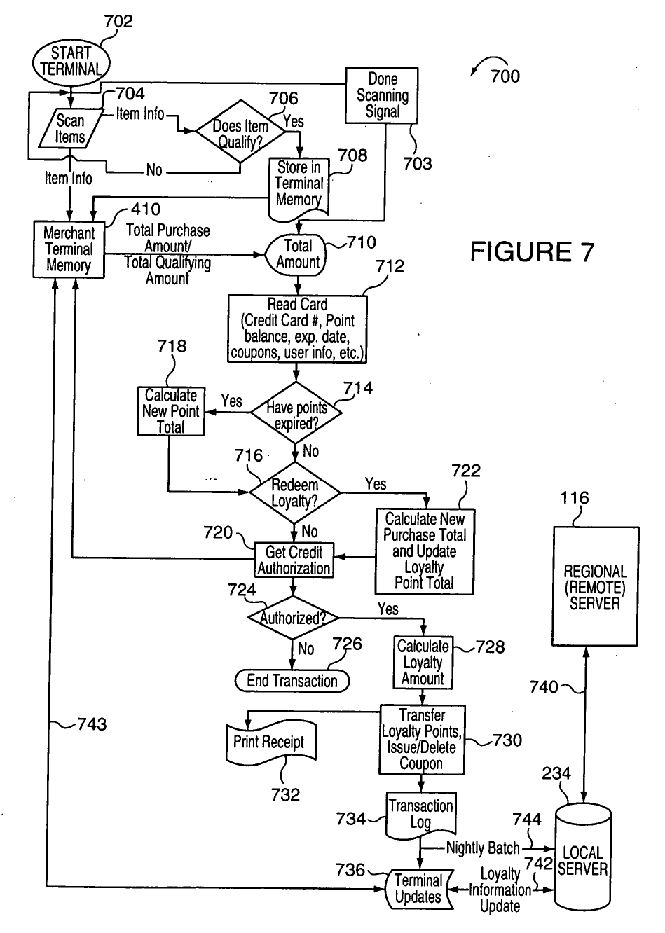

FIG. 7 is a combined system and method diagram 700 which shows various system components and steps of a loyalty program method implemented in accordance with one exemplary embodiment of the invention. In FIG. 7 illustrates components of the system implementing the exemplary loyalty program include a regional server 116 which is coupled by a communications link to a local, e.g., store based, server 234. As discussed above, the regional server 116 may be located in a location which is physically remote from the local server 234 and the various merchant terminals it controls. Many of the steps shown in the diagram 700 are performed by one or more merchant terminal components, e.g., a processor, under control of a point calculation routine which uses a set of point calculation program information stored in merchant terminal memory 410 shown in FIG. 7.

The exemplary loyalty program method shown in FIG. 7 includes various steps relating to the updating of merchant terminals and the retrieval of information from various merchant terminals in addition to steps performed at individual merchant terminals to grant and redeem loyalty program points and/or issue other discounts in accordance with loyalty program being implemented at a particular point in time. The regional server 116 communicates with one or more local servers 234 dynamically or at predetermined, e.g., scheduled times or at a time controlled by a system or loyalty program administrator. The updating may be triggered by interaction by a loyalty program administrator with the regional server via a web based interface used to manage one or more loyalty programs. The step, represented by arrow 740, of communicating loyalty program information may includes transmitting one or more sets of loyalty program information, e.g., different sets of loyalty program information for different departments within a store. In addition to transmitting an update of loyalty program information to the local server 234, in step 740, the regional server may also receive information about the implemented loyalty program from the local server 234. For example, the local server 234 may communicate information on loyalty program points awarded since the last update, loyalty program points redeemed by the merchant terminals coupled to the local server 234, e.g., the merchant terminals in a store, sales information, and information on the current total number of outstanding awarded loyalty points stored on user devices which were accessed by the merchant terminals coupled to the local server 234 since the last update. Local server 234 propagates updated loyalty program information sets 736, e.g., intended for specific store departments, to the merchant terminals in those departments for which the updates are intended. Arrows 742 and 743 are used to represent the communication of updated loyalty program information to the memory 410 of a merchant terminal which is to use the updated information to implement the loyalty program. Such information may indicate a number of points earned per dollar spent. The arrows 742, 743 are bi-directional to show that the local server 234 may receive as part of the update process, loyalty program information from the merchant terminal memory 410. This information may include the above discussed information which may be communicated from the local server 234 to the regional server 116. For example, it may include information on loyalty program points awarded since the last update, loyalty program points redeemed by the particular merchant terminal being updated, information about products purchased and total sales at the terminal since the last update, and information on the current total number of outstanding awarded loyalty points stored on user devices which were accessed by the particular merchant terminal being updated. Other transaction information may also be communicated to the local server and ultimate to the regional server 116 including, e.g., other sales and/or customer information obtained from accessing a customer's portable user device and/or completing a sale involving the use of a customer's portable user device. Terminal transaction information of the type discussed may be stored in the form of a terminal transaction log 734 which is communicated to the local server 234 periodically, e.g., nightly, in step 744 in the absence of an update of the terminal's loyalty program information and/or at the time of a loyalty program information update as represented by arrows 743, 742.

As with updates of loyalty program information to the local server 234 from the regional server 116, updates of the sets of loyalty program information stored in individual merchant terminals may occur at predetermined scheduled times, e.g., on a nightly batch basis, or at other times such as when triggered by a manager of the loyalty program. Local merchant terminal updates may be triggered by store managers and/or other administrators accessing the local server 234, e.g., via a Web interface, and scheduling or initiating an update of one or more merchant terminals coupled to the local server 234. Updates of the local server 234 and merchant terminals may involve the use of one or more different types of communications links including the use of wireless communications links. For example, the information communicated in the update steps represented by arrows 743, 742 may be communicated using wireless links used to coupled one or more individual merchant terminals to the local server 234.

Having generally described the process of updating a loyalty program information set in a merchant terminal and the return of information from the terminal to a local server 234 and ultimately a regional server 116, we will now discuss steps involved with the granting and/or redeeming of loyalty points and/or other discounts at a terminal implemented in accordance with the invention.

Terminal operation is generally shown as starting in step 702, e.g., when a terminal operator activates the terminal so that it can be used to service a customer. This may involve a cashier activating the terminal or, in the case of self server terminals, a manager activating the terminal so it can be used by a customer without cashier involvement. With the merchant terminal active, the terminal can receive input from a user, e.g., cashier or customer. Input may be, e.g., scanning of an item or another signal such a signal generated by pressing a button on the terminal to indicate that all items to be purchased have been scanned.

If an item is scanned, operation proceeds to step 704 in which one or more items are scanned and the information identifying the scanned item is produced, e.g., a number identifying the item such as a UPC code. As part of the scanning step 704, information about the scanned items is stored in the merchant terminal's memory 410, e.g., for creating a list of items which are being purchased and for generating a total purchase price. To determine if a scanned item qualifies for a discount, a loyalty point award, and/or can be paid for or discounted through the redemption of previously awarded loyalty points operation proceeds to step 706. In step 706, the merchant terminal compares information identifying the item being purchased, e.g., the UPC (bar code number) of a scanned item, to information in the set of loyalty program information stored in the merchant terminal which is scheduled to be used at the time of the purchase transaction, to determine if the item being purchased qualities under the loyalty program, e.g., for a discount or other special treatment as compared to non-qualifying items. If in step 706, it is determined that the item does not qualify, processing returns to end of start step 702, where the next item is scanned and/or a scanning complete signal 703 is received, e.g., in response to the customer or cashier pressing a button indicating that all times for a purchase transaction have been scanned. However, if a scanned item qualifies under the loyalty program, operation proceeds to step 708 where information identifying the item and/or purchase price is stored in the terminals memory 410 as part of a list of qualified items being purchased and corresponding item information such as the qualifying item's purchase price. In some embodiments all purchases corresponding to a store or department may qualify.

In response to a terminal user entering a done scanning signal 703, indicating that the full set of items to be purchased have been scanned, operation proceeds to step 710. In step 710, the total amount of qualifying items and items to be purchased is obtained from memory 410 for use in completing the transaction. The total amount information retrieved from memory in step 710 is supplied as input to step 712. In step 712, the portable user device, e.g., smart card, of the user making the purchase is read by the merchant terminal. The information retrieved from the user's card may include, e.g., a credit card number or bank account number which can be used to pay for purchases, information on the user's loyalty program point balance such as the total number of unredeemed loyalty points accumulated by the user, information indicating expiration dates for various loyalty point awards and/or the credit card, information on electronic coupons which have been given to the user, e.g., as part of a previous purchase transaction, user information such as the name and/or address of the user and other information relating to the user, account balances and/or the loyalty program such as how frequently the particular user has visited the store and/or particular department within the store where the current purchase is being made.

With the information on the user's card having been read, the information is processed in step 714 to determine if any of the accumulated points have expired, e.g., since the last time the user used the card. If accumulated loyalty points have expired, operation proceeds to step 718 where a new accumulated loyalty point total is calculated, e.g., the expired points are deleted by the terminal from the total accumulated points read from the card. The terminal may store information on the deleted unredeemed points and report them back to the local server 234 for use in evaluating success of the loyalty program and updating the point information stored in the local or regional server for the user involved in the transaction, e.g., as backup to the point information stored on the user device.

Operation proceeds from step 718 with the new accumulated loyalty point total reflecting the deduction of expired points to step 716. Operation proceeds directly from step 714 to step 716 in the case where no loyalty points have expired. In step 716, a determination is made as to whether the user making the purchase wants to redeem loyalty points. This may involve using a video display to prompt the user to indicate whether or not they want to redeem points. If loyalty points are not going to be redeemed, operation proceeds directly from step 716 to credit authorization step 720. If the user indicates a desire to redeem loyalty points, operation proceeds to step 722. In step 722, the user redeems loyalty points. This may involve using the loyalty points to obtain a discount on one or more purchased items or getting one or more of the items for free. The discount is determined based on the set of stored loyalty program information stored in the merchant terminal's memory 410. The discount may depend, e.g., on the item purchased, the time and/or date of purchase, and/or the department or terminal location within the store, e.g., with different departments in a store possibly providing different promotions and/or discounts at the same point in time. The redeemed points used to obtain the discount and/or free items are deleted from the user's accumulated point total in step 722 which also involves calculating a new total purchase price to reflect the savings associated with the redemption of the accumulated loyalty points. Operation proceeds from step 722 to credit authorization step 720. In step 720, a credit authorization check is made to receive authorization to charge the total purchase price for the merchandise being purchased. The results of the merchant terminal authorization may be stored in terminal memory 410.

Operation proceeds from step 720 to step 724 where the results of the credit authorization are considered to determine if the purchase should be denied. If in step 724, it is determined that the charge to the credit card number read from the user's portable device or bank account has been denied, the transaction is terminated in step 726 with the merchant terminal refusing to complete the sale transaction due to the failure of the charge for the purchase to be authorized.

However, if in step 724 it was determined that the charge for the purchase was authorized, operation proceeds to step 728. In step 728, the number of loyalty program points to be awarded is calculated. This calculation is performed using the set of loyalty program information that was stored in the merchant's terminal for use during the time period in which the purchase was made. As discussed above, different sets of information may be used during different periods of time. Accordingly, the total points to be awarded may depend, in part, on the time of the purchase, the store department in which the purchase is made and/or other factors. For example, different departments within a store may provide different numbers of bonus points on the same total purchase amount as part of department specific promotions.

With the loyalty point award having been determined in step 728, operation proceeds to step 730 in which the new loyalty point information is transferred, e.g., recorded on the user's device and/or transaction log 734. Electronic coupons may also be issued at the time of purchase and stored on the user's portable device in step 730. The coupons may be for goods purchased to encourage additional purchases and/or for items which the loyalty program is seeking to encourage the user to purchase. The updated loyalty point total stored in the user's card in step 730 will reflect the deletion of expired and/or redeemed loyalty points in addition to any points awarded as a result of the current purchase transaction.

With the transfer of the updated loyalty point information to the user's portable device and to the transaction log stored in the terminal's memory the loyalty point portion of the transaction is complete. In terminal 732 a receipt is printed at the terminal to provide the user a hard copy of the transaction information, e.g., purchase and loyalty point awards. As discussed above, the transaction log 734 may be provided to the local server 234 and/or regional server 116 during a terminal update and/or scheduled information transfer, e.g., as part of a nightly batch processing operation.

While the FIG. 7 embodiment illustrates the use of both a regional server 116 and a local server 234, it should be appreciated that the regional server can, and in various embodiments does, interact directly with merchant terminals. In such embodiments, a local store server need not be used.

While generally described in the context of networked terminals, it should be appreciated that merchant terminals need not be networked to participate in the loyalty program implemented in accordance with the invention. The memory in merchant terminals used to store loyalty point information and/or the processor used to perform loyalty point calculations can, and in some embodiments are, implemented on a removable card. In such embodiments a store manager can, and in some embodiments does, update loyalty program information in individual terminals by replacing the card in a terminal, which stores a set of loyalty program information, with another card with an updated set of loyalty point program information stored thereon. The replacement cards may be loaded with the updated program information set or sets at the store's server and then manually inserted into the individual merchant terminals by the store manager to thereby update the individual merchant terminals without the need to connect them to the store or regional server.

In some embodiments, various features of the present invention are implemented using modules. Such modules may be implemented using software, hardware, or a combination or software and hardware.

Various features of the present invention may be implemented in software. Such software is stored on a machine readable, e.g., the memory in the smart card or memory in the card reader/writer device. Accordingly, the present invention is directed to, among other things, a machine readable medium including computer executable instructions for controlling a device to perform one or more steps in accordance with the method of the present invention.

Numerous variations on the above described exemplary embodiments are possible while remaining within the scope of the invention.

What is claimed is:

1. A system for managing loyalty programs which uses at least one portable user device to store data including loyalty points, said system comprising:
a server for distributing loyalty point program information; and
a plurality of merchant terminals coupled to said server, said plurality of merchant terminals including at least a first merchant terminal and a second merchant terminal, said first and second merchant terminals being located at different locations within a first store;
the first merchant terminal comprising:
i) a memory for storing a first set of loyalty point program information, said first set of loyalty point program information including information about award points to be accorded for purchases made at said first terminal;
ii) a first interface for receiving loyalty point program information updates from said server;
iii) a first user device interface for reading from and writing to a portable user device; and
the second merchant terminal comprising:
i) a memory for storing a second set of loyalty point program information, said second set of loyalty point program information including information about award points to be accorded for purchases made at said second terminal, the second set of loyalty point information being either: different from said first set of loyalty point information and providing for loyalty points to be awarded at a rate or in an amount that is different from a rate or an amount at which loyalty points are awarded by said first terminal in accordance with the first set of loyalty program information or being the same as the first set of loyalty point program information and providing for loyalty points to be awarded for items corresponding to a first department at a rate or in an amount that is different from a rate or an amount at which loyalty points are to be awarded for items corresponding to a second department which is different from said first department;
ii) a second interface for receiving loyalty point program information updates from said server; and
iii) a second user device interface for reading from and writing to a portable user device.

2. The system of claim 1, wherein the first merchant terminal further comprises:
a first loyalty point calculation module for calculating loyalty points as a function of information included in said first set of loyalty point program information, information read from a portable user device associated with a user making a purchase, and information about an item being purchased; and
wherein the second merchant terminal further comprises:
a second loyalty point calculation module for calculating loyalty points as a function of information included in said second set of loyalty point program information, information read from a portable user device associated with a user making a purchase, and information about an item being purchased.

3. The system of claim 1, wherein a portable user device associated with a user making a purchase on the first terminal includes:
a loyalty point calculation module for calculating loyalty points as a function of information included in said first set of loyalty point program information, information stored in said portable user device, associated with a user making a purchase on the first terminal, and information about an item being purchased.

4. The system of claim 1,
wherein said at least one portable user device is a card; and
wherein said first and second sets of loyalty point information can be modified independently on each of said first and second merchant terminals, respectively, from information communicated to the individual terminal from said server.

5. The system of claim 1, wherein said server is a local server located in said first store, said local server including multiple sets of loyalty point program information, at least some different loyalty point program information sets corresponding to different departments within said store, said first and second terminals each being supplied with different sets of loyalty point program information, said different sets corresponding to different departments in which said first and second terminals are located, respectively.

6. The system of claim 1, wherein said server is a local server located in said first store, said local server including multiple sets of loyalty point program information, at least some different loyalty point program information sets corresponding to different locations within said store, said first and second terminals each being supplied with different sets of loyalty point program information, said different sets corresponding to different locations at which said first and second terminals are located in said first, respectively.

7. The system of claim 2, wherein said first loyalty point calculation module determines loyalty points to be awarded for a purchase of a first item based on said first item's price, said second loyalty point calculation module determines loyalty points to be awarded for a purchase of a second item based on said second item's price, the loyalty point calculation performed by said first and second terminals awarding different numbers of points for similarly priced items.

8. The system of claim 7, wherein said determination of loyalty points, to be awarded by first and second loyalty point calculation modules, is a function of user data read from a portable user device associated with a user making the purchase, said determination of loyalty points being different for users who are members of different user groups.

9. The system of claim 7, wherein said first and second sets of loyalty point program information include different weights to be used in calculating the number of loyalty points to be awarded for a purchase.

10. The system of claim 9, wherein said first and second sets of loyalty point program information include time period information indicating a time period in which said set of loyalty point program information should be used, a different time period being indicated for said first and second sets of loyalty point program information.

11. The system of claim 7, wherein said portable user device utilized in said loyalty point calculation is a card which includes stored information indicating the frequency of prior visits to said first store by said user, said first and second loyalty points calculation modules using said frequency information in determining the number of loyalty points to be awarded.

12. The system of claim 7, wherein said portable user device utilized in said loyalty point calculation includes stored information indicating the frequency of prior visits to a department in said first store by said user, said first and second loyalty points calculation modules using said frequency information in determining the number of loyalty points to be awarded.

13. The system of claim 1, wherein said first loyalty point calculation is based on the date said first item is purchased.

14. The system of claim 1, wherein said first loyalty point calculation is based on the time said first item is purchased.

15. The system of claim 1, wherein said plurality of merchant terminals includes a third merchant terminal and a fourth merchant terminal, said third and fourth merchant terminals being located in a second store, the first and second stores being different,
the third merchant terminal comprising:
i) a memory for storing a third set of loyalty point program information, said third set of loyalty point program information including information about award points to be accorded for purchases made at said third terminal;
ii) a third interface for receiving loyalty point program information updates from said server;
iii) a third user device interface for reading from and writing to a portable user device; and
the fourth merchant terminal comprising:
i) a memory for storing a fourth set of loyalty point program information, said fourth set of loyalty point program information including information about award points to be accorded for purchases made at said fourth terminal, the fourth set of loyalty point information being different from said third set of loyalty point information, said fourth set of loyalty point information providing for loyalty points to be awarded at a rate or in an amount that is different from a rate or an amount at which loyalty points are awarded by said third terminal in accordance with the third set of loyalty program information;
ii) a fourth interface for receiving loyalty point program information updates from said server; and
iii) a fourth user device interface for reading from and writing to a portable user device.

16. The system of claim 1, wherein said plurality of merchant terminals includes a third merchant terminal, said third merchant terminal being located in a second store, the first and second stores being different,
the third merchant terminal comprising:
i) a memory for storing a third set of loyalty point program information, said third set of loyalty point program information being different from said first and second sets of loyalty point program information and including information about award points to be accorded for purchases made at said third terminal;
ii) a third interface for receiving loyalty point program information updates from said server; and
iii) a third user device interface for reading from and writing to a portable user device.

17. The system of claim 1, wherein said server is a regional server managing loyalty plan participating stores in a geographic region including multiple stores located at different physical locations.

18. The system of claim 1, wherein said portable user devices each comprise a microprocessor and a nonvolatile data storage module for storing user information.

19. The system of claim 15, wherein said server is a local server located in said store, the system further comprising:
a regional server located remotely from said first, second, third and fourth stores, said regional server including different sets of loyalty point program information for different regions; and means for transmitting to said local server at least one set of loyalty point program information corresponding to the region in which said local server is located.

20. The system of claim 19, wherein said regional server further includes different sets of loyalty point program information corresponding to at least two different store chains owned by different owners.

21. The system of claim 1, wherein at least one of said sets of loyalty point program information includes a list of items, loyalty bonus point weights, and dates of bonus programs indicating when loyalty points are to be awarded.

22. The system of claim 1, wherein said first terminal writes information updating stored loyalty point information on a portable user device in response to a purchase being made at said first terminal using the portable user device to which said loyalty point information is written.

23. The system of claim 1, wherein said first user device interface is a wireless interface for obtaining information from, and writing information to, a portable user device.

24. A server for distributing loyalty point information to a plurality of merchant terminals, said plurality of merchant terminals including first and second terminals located in a first store, the server comprising:
a memory including multiple stored sets of loyalty point program information, at least some different loyalty point program information sets corresponding to different departments within said first store; and
a terminal interface for communicating to said first and second first and second merchant terminals different sets of loyalty point program information, said different sets corresponding to different departments in which said first and second terminals are located, respectively.

25. The server of claim 25, wherein said server is store server located in said first store in which said first and second terminals are located, at least some of said multiple stored sets of loyalty point program information corresponding to different periods of time in which said information is to be used by one of said first and second terminals.

26. The server of claim 24, wherein said server is a regional server, said regional server, at least some of said multiple stored sets of loyalty point program information corresponding to different stores located in different geographic regions.

27. A method of implementing at least one loyalty scheme which includes the use of portable user devices to store data including loyalty points, said method comprising:
operating a server to distribute loyalty point program information; and
operating a plurality of merchant terminals coupled to said server to perform loyalty program functions, said plurality of merchant terminals including at least a first merchant terminal and a second merchant terminal, said first and second merchant terminals being located at different locations within a first store, the step of operating a plurality of merchant terminals including:
operating the first merchant terminal to store a first set of loyalty point program information, said first set of loyalty point program information including information about award points to be accorded for purchases made at said first terminal;
operating the first merchant terminal to receive loyalty point program information updates from said server used to update said stored first set of loyalty point program information;
when a user makes a purchase at the first merchant terminal using a portable user device, operating the first merchant terminal to read from and write to the portable user device at least some loyalty program information;
operating the second merchant terminal to store a second set of loyalty point program information, said second set of loyalty point program information including information about award points to be accorded for purchases made at said second terminal, the second set of loyalty point information being either: different from said first set of loyalty point information and providing for loyalty points to be awarded at a rate or in an amount that is different from a rate or an amount at which loyalty points are awarded by said first terminal in accordance with the first set of loyalty program information or being the same as the first set of loyalty point program information and providing for loyalty points to be awarded for items corresponding to a first department at a rate or in an amount that is different from a rate or an amount at which loyalty points are to be awarded for items corresponding to a second department which is different from said first department;
operating the second merchant terminal to receive loyalty point program information updates loyalty point program information updates from said server; and
when a user makes a purchase at the second merchant terminal using a portable user device, operating the second merchant terminal to read from and write to the portable user device at least some loyalty program information.

28. The method of claim 27, further comprising:
operating the server to transmit loyalty point program information updates on a predetermine schedule.

29. The method of claim 28, wherein at least some merchant terminals are updated with loyalty point program information multiple times in a single day to implement loyalty point programs which are effective during different time periods of the day, some of said different time periods lasting less than 3 hours in duration.

30. The method of claim 26, wherein said server is a regional server, the method further comprising:
transmitting different loyalty point program information updates to terminals in stores corresponding to different companies.

31. The method of claim 30, wherein said first and second sets of loyalty point program information are the same and include information for awarding loyalty points for items corresponding to at least two different store departments at different rates.

32. The method of claim 30, where the first and second sets of loyalty point program information are different, said second set of loyalty point program information including information for awarding loyalty points on purchases at a different rate, than said first set of loyalty point program information, for the same items or items of the same type.
